(19) United States
(12) Patent Application Publication
(10) Pub. No.: US 2017/0133763 A1
(43) Pub. Date: May 11, 2017

(54) PATCH ANTENNA

(71) Applicant: FUJITSU LIMITED, Kawasaki-shi (JP)

(72) Inventor: Yusuke Suzuki, Fujisawa (JP)

(73) Assignee: FUJITSU LIMITED, Kawasaki-shi (JP)

(21) Appl. No.: 15/332,452

(22) Filed: Oct. 24, 2016

(30) Foreign Application Priority Data
Nov. 6, 2015 (JP) 2015-218468

(51) Int. Cl. H01Q 9/04; H01Q 1/50; H01Q 1/48

(52) U.S. Cl. CPC H01Q 9/0407; H01Q 1/48; H01Q 1/50

(57) ABSTRACT

A patch antenna includes a substrate formed of a dielectric, a conductive ground electrode disposed on one surface of the substrate, and a conductive radiation electrode disposed on another surface of the substrate, wherein the conductive radiation electrode includes a first element, a second element, a power feeding point, and a notched portion formed between the first element and the second element along a diagonal direction passing through the power feeding point.

### CROSS-REFERENCE TO RELATED APPLICATION

This application is based upon and claims the benefit of priority of the prior Japanese Patent Application No. 2015-218468, filed on Nov. 6, 2015, the entire contents of which are incorporated herein by reference.

### FIELD

The embodiment discussed herein is related to a patch antenna usable for a plurality of linearly polarized waves having planes of polarization in different directions.

### BACKGROUND

As an antenna, there has been a patch antenna (also referred to as a microstrip antenna), conventionally. The patch antenna has a grounded electrode (hereinafter referred to as a ground electrode) provided on one surface of a dielectric substrate and has an electrode which radiates or receives electric waves (hereinafter referred to as a radiation electrode) provided on the other surface of the substrate. The patch antenna may be manufactured by using etching to allow production at low cost. Also, since the patch antenna may be provided on the same substrate as that of a semiconductor element for communication processing and so forth, application as a basic element of an active antenna, a multi-antenna for mobile communication, or the like has been studied.

In a patch antenna with a radiation electrode formed in a rectangular shape, for example, the length of one side of the radiation electrode is set at ½ of an electrical length corresponding to a design wavelength. Also, by feeding power to the radiation electrode at a position along any side of the radiation electrode at ¼ of the length of that side from one end of the radiation electrode, impedance matching is established in the radiation electrode with a linearly polarized wave having a plane of polarization along that side. Therefore, the patch antenna is capable of radiating or receiving a linearly polarized wave having this plane of polarization.

In general, a positional relation between a communication apparatus having a patch antenna and another communication apparatus for wireless communication with that communication apparatus may not be fixed. For example, when the communication apparatus is a base station and the other communication apparatus is a mobile station, the orientation of the mobile station with respect to the base station may be changed even when the base station and the mobile station are performing wireless communication. Thus, the patch antenna for use in these communication apparatuses is preferably usable for two linearly polarized waves orthogonal to each other.

To radiate or receive two linearly polarized waves orthogonal to each other, a technique has been conventionally used in which power is fed alternately to an antenna for horizontally polarized waves and an antenna for vertically polarized waves by using a switch or power is fed thereto by using a distributer.

However, since a switch for switching power feeding or a power distributor is used together with two antennas in related art, this related art is not suitable for decreasing the size and cost of the communication apparatus.

Meanwhile, an antenna for receiving linearly polarized waves has been suggested (for example, refer to Japanese Laid-open Patent Publication No. 7-176942), in which both of horizontally polarized waves and vertically polarized waves are usable by using one patch antenna element. In this antenna for receiving linearly polarized waves, two power feeding circuits are connected to the patch antenna element from directions orthogonal to each other. As for each power feeding circuit, an impedance circuit network is connected to the power feeding circuit at a position at a length of substantially ¼ of the wavelength of an electric wave from the patch antenna element. With each impedance circuit network being set in a short circuit state, a horizontally polarized signal or a vertically polarized signal is extracted from a relevant power feeding circuit.

Japanese Laid-open Patent Publication No. 7-176942 is an example of related art.

However, also in the antenna for receiving linearly polarized waves disclosed in Japanese Laid-open Patent Publication No. 7-176942, two power feeding circuits for horizontally polarized waves and vertically polarized waves and impedance circuit networks are used. Therefore, this antenna for receiving linearly polarized waves is also disadvantageous in decreasing the size and cost.

### SUMMARY

According to an aspect of the invention, a patch antenna includes a substrate formed of a dielectric, a conductive ground electrode disposed on one surface of the substrate, and a conductive radiation electrode disposed on another surface of the substrate, wherein the conductive radiation electrode includes a first element configured to radiate or receive a first linearly polarized wave with a predetermined design wavelength having a plane of polarization along a first direction, a second element configured to radiate or receive a second linearly polarized wave with the predetermined design wavelength having a plane of polarization along a second direction orthogonal to the first direction and have a portion common to the first element, a power feeding point provided at a position where impedance matching is established in the conductive radiation electrode for the first linearly polarized wave and the second linearly polarized wave in the portion common to the first element and the second element, and a notched portion formed between the first element and the second element along a diagonal direction passing through the power feeding point, the notched portion configured to equally divide a corner between the first direction and the second direction into two.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view of a patch antenna according to one embodiment;

FIG. 2 is a schematic sectional side view of the patch antenna according to the embodiment;

FIG. 3 is a schematic plan view of a radiation electrode according to a modification example;

FIG. 4 is a diagram depicting results of an experiment regarding the radiation electrode depicted in FIG. 3, representing a relation between a length of a notched portion along a diagonal direction connecting a power feeding point and the notched portion and a difference between a total gain of polarization components in horizontal and vertical directions and a gain of polarization components in a direction at 45° with respect to the horizontal direction;

FIG. 5A is a schematic plan view of a radiation electrode of a comparative patch antenna;

FIG. 5B and FIG. 5C are diagrams depicting results of an experiment of radiation characteristics of the comparative patch antenna;

FIG. 5D is a diagram depicting results of an experiment of radiation characteristics of a patch antenna using the radiation electrode depicted in FIG. 3;

FIG. 6 is a diagram depicting results of an experiment regarding the patch antenna using the radiation electrode depicted in FIG. 3, representing a relation between frequency, and voltage standing wave ratio and impedance;

FIG. 7A is a diagram depicting results of an experiment regarding the comparative patch antenna, representing a relation between frequency, and voltage standing wave ratio and impedance when power is fed to the radiation electrode at a power feeding point V;

FIG. 7B is a diagram depicting results of an experiment regarding the comparative patch antenna, representing a relation between frequency, and voltage standing wave ratio and impedance when power is fed to the radiation electrode at a power feeding point H; and

FIG. 8A to FIG. 8D are schematic plan views of radiation electrodes according to modification examples.

### DESCRIPTION OF EMBODIMENT

The embodiment is to provide a patch antenna capable of radiating or receiving two linearly polarized waves orthogonal to each other by using one radiation electrode.

In the following, the patch antenna is described with reference to the drawings.

For respective linearly polarized waves in two directions orthogonal to each other (in the following, these directions are assumed to be a horizontal direction and a vertical direction for convenience), this patch antenna is provided with a common power feeding point at a position on a radiation electrode where impedance matching is established in the patch antenna. Also in this patch antenna, on a diagonal side with respect to the position where the common power feeding point is provided, a notched portion is formed in the radiation electrode. With this, in this patch antenna, one radiation electrode is used without using different circuits for power feeding for linearly polarized waves in the horizontal direction and linearly polarized waves in the vertical direction, and the patch antenna is usable in common for these linearly polarized waves in two directions. Note that a linearly polarized wave in the horizontal direction is hereinafter referred to as a horizontally polarized wave and a linearly polarized wave in the vertical direction is hereinafter referred to as a vertically polarized wave.

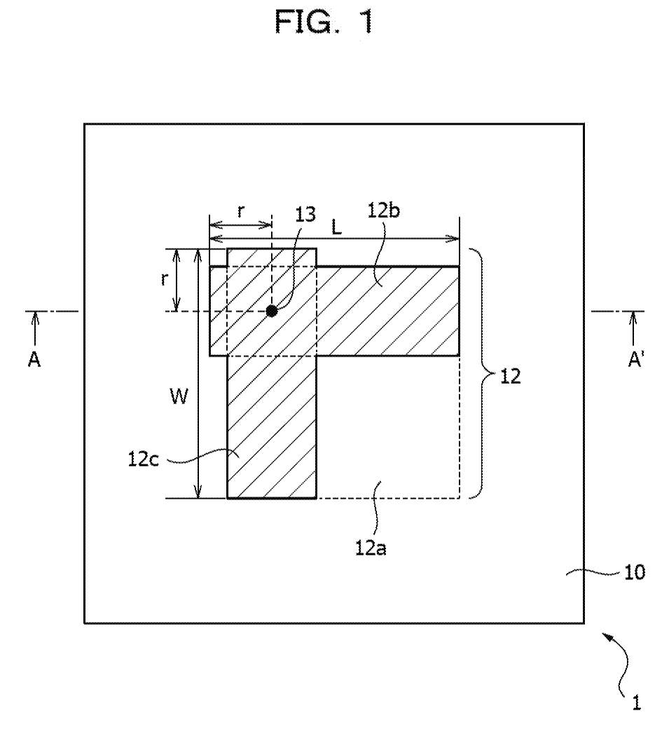

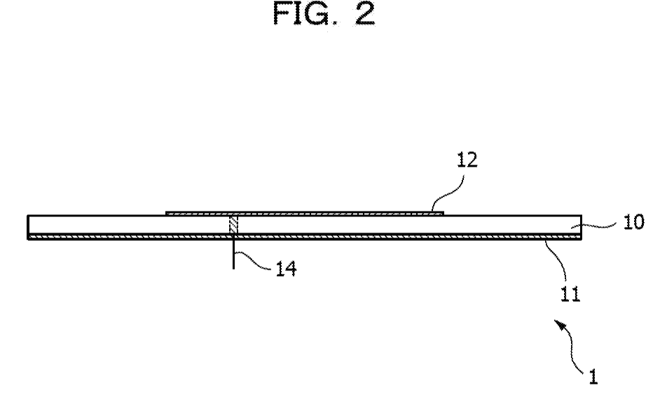

FIG. 1 is a schematic plan view of a patch antenna according to one embodiment, and FIG. 2 is a schematic sectional side view of the patch antenna when a II-II line of FIG. 1 is viewed from an arrow.

A patch antenna 1 has a substrate 10, a ground electrode 11 provided on one surface (a lower surface in FIG. 2) of the substrate 10, and a radiation electrode 12 provided on the other surface (an upper surface in FIG. 2) of the substrate 10.

The substrate 10 is formed of a dielectric, and supports the ground electrode 11 and the radiation electrode 12 with a predetermined space.

The ground electrode 11 is a grounded, flat-plate-shaped conductor. The ground electrode 11 is disposed so as to overlap the entire radiation electrode 12 when the patch antenna 1 is viewed from above. Also, the ground electrode 11 is formed in a rectangular shape, and the area of the ground electrode 11 is preferably larger than the area of the radiation electrode 12. For example, the ground electrode 11 is formed so that the length of the side of the ground electrode 11 in the horizontal direction is twice as long as the length of the side of the radiation electrode 12 in the horizontal direction or longer and the length of the side of the ground electrode 11 in the vertical direction is twice as long as the length of the side of the radiation electrode 12 in the vertical direction or longer. With this, regarding radio waves radiated from the patch antenna 1, directivity in a direction along the direction of the normal to the substrate 10 is improved.

The radiation electrode 12 is a flat-plate-shaped conductor, and is provided on the opposite side of the ground electrode 11 across the substrate 10. The radiation electrode 12 receives a signal with a frequency corresponding to a predetermined design wavelength from a communication circuit (not depicted) via a power feeding line 14 connected at a power feeding point 13, and radiates the signal into the air as a radio wave having a horizontally polarized component and a vertically polarized component. Alternatively, the radiation electrode 12 has a plurality of frequencies corresponding to predetermined design wavelengths, and receives a radio wave having a horizontally polarized component and a vertically polarized component for output as an electrical signal via the power feeding line 14 to the communication circuit.

As described above, in the rectangular-shaped patch antenna, to allow a radio wave having a frequency corresponding to a predetermined design wavelength to be radiated or received, the lengths of the radiation electrode in the horizontal direction and the vertical direction are each represented by the following expression.

$$\frac{λ}{2 \sqrt{ɛ}} \qquad ( 1 )$$

Here, λ is a design wavelength, and ∈ is a relative permittivity of the substrate 10.

In the present embodiment, the patch antenna 1 is formed so as to be usable for a horizontally polarized wave and a vertically polarized wave. Thus, the radiation electrode 12 has a first element 12b in a rectangular shape and a second element 12c in a rectangular shape having a portion common to the first element 12b. In addition, as will be described further below, the radiation electrode 12 is provided with a recessed-shaped notched portion 12a between the first element 12b and the second element 12c. For this reason, the width of the first element 12b in the vertical direction is shorter than a length L of the first element 12b in the horizontal direction. Thus, for radiation or reception of a horizontally polarized wave having a predetermined design wavelength, the length L of the first element 12b in the horizontal direction is longer than the length represented by the expression (1). Similarly, the width of the second element 12c in the horizontal direction is shorter than a length W of the second element 12c in the vertical direction. Thus, for radiation or reception of a vertically polarized wave having a predetermined design wavelength, the length W of the second element 12c in the vertical direction is longer than the length represented by the expression (1).

Furthermore, in the common portion between the first element 12b and the second element 12c, the power feeding point 13 is provided at the position where impedance matching is established in the radiation electrode 12 for both of horizontally polarized waves and vertically polarized waves. Specifically, for impedance matching of the eradiation electrode 12 with respect to horizontally polarized waves, the power feeding point 13 is provided at a position at L/4 from a left end of the radiation electrode 12 along the side in the horizontal direction. Furthermore, for impedance matching of the radiation electrode 12 with respect to vertically polarized waves, the power feeding point 13 is provided at a position at W/4 from an upper end of the radiation electrode 12 along the side in the vertical direction. That is, when a distance from the left end or upper end of the radiation electrode 12 to the power feeding point 13 is taken as r, the common power feeding point 13 for both of horizontally polarized waves and vertically polarized waves is provided at a position where the following expression holds.

$$\frac{r}{L} = \frac{r}{W} = \frac{1}{4} \qquad ( 2 )$$

Also in the present embodiment, in the radiation electrode 12, the recessed-shaped notched portion 12a which equally divides each of the horizontal direction and the vertical direction into two is formed along a diagonal direction passing through the power feeding point 13 and on the opposite side of the power feeding point 13. This allows an improvement in density of current flowing along the horizontal direction or the vertical direction in the radiation electrode 12. Therefore, the patch antenna 1 may efficiently radiate a horizontally polarized wave and a vertically polarized wave.

Furthermore, the radiation electrode 12 is preferably formed symmetrically with respect to the diagonal direction passing through the power feeding point 13 so that a difference between radiation characteristics for horizontally polarized waves and radiation characteristics for vertically polarized waves is small.

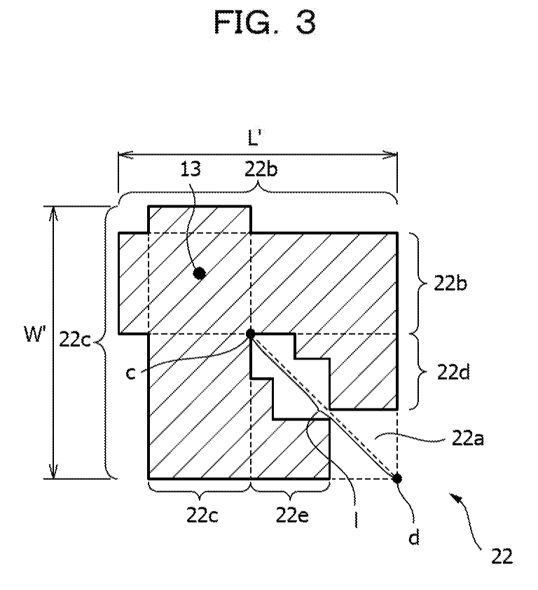

FIG. 3 is a schematic plan view of a radiation electrode according to a modification example. A radiation electrode 22 according to the modification example has a length L′ in the horizontal direction and a length W′ in the vertical direction which are shorter than the length L in the horizontal direction and the length W in the vertical direction, respectively, of the radiation electrode 12 depicted FIG. 1. Thus, the radiation electrode 22 is provided with step-shaped stubs 22d and 22e so as to be opposed to each other across a notched portion 22a. That is, the stub 22d is formed so that one end of a first element 22b extending in the horizontal direction for horizontally polarized waves in the radiation electrode 22, the one end being opposite to the power feeding point 13, that is, a right end, protrudes to the second element 22c side, that is, downward. Also, the stub 22e is formed so that one end of a second element 22c extending in the vertical direction for vertically polarized waves in the radiation electrode 22, the one end being opposite to the power feeding point 13, that is, a lower end, protrudes to the first element 22b side, that is, rightward. For example, the width of the stub 22d in the vertical direction is set so that the length U of the first element 22b is a length represented by the expression (1), that is, λ/(2√∈). Similarly, for example, the width of the stub 22e in the horizontal direction is set so that the length W′ of the second element 22c is λ/(2√∈). Also, to disable current to flow between the stub 22d and the stub 22e without passing through the first element 22b and the second element 22c, the stub 22d and the stub 22e are disposed so as to be open ends with respect to each other, that is, so as not be electrically contacted with each other. With this, a reduction in radiation efficiency of horizontally polarized waves and vertically polarized waves due to the provision of the stubs 22d and 22e is decreased.

As described above, with the provision of the stub 22d, even if the length L′ of the radiation electrode 22 along the horizontal direction is shorter than the length L, the radiation electrode 22 is able to radiate or receive a horizontally polarized wave with the design wavelength λ. Similarly, with the provision of the stub 22e, even if the length W′ of the radiation electrode 22 along the vertical direction is shorter than the length W, the radiation electrode 22 is able to radiate or receive a vertically polarized wave with the design wavelength λ. Also in this modification example, for impedance matching of the radiation electrode 22 for horizontally polarized waves and vertically polarized waves, a distance from an upper end of the radiation electrode 22 to the power feeding point 13 and a distance from a left end of the radiation electrode 22 to the power feeding point 13 are set so as to satisfy the expression (2). That is, the distances from the upper and left ends of the radiation electrode 22 to the power feeding point 13 are ¼ of W′ and L′, respectively.

Note that to improve efficiency with respect to horizontally polarized waves and vertically polarized waves, the gain of the patch antenna 1 for a horizontally polarized wave and a vertically polarized wave is preferably higher than the gain of the patch antenna 1 for polarized waves in other directions because, as for polarized waves in directions other than the horizontal direction and the vertical direction, the radiation electrode oscillates with a polarized wave with a wavelength different from the design wavelength. For this reason, the notched portion 22a preferably has a predetermined length or longer from one end opposite to the power feeding point 13 along the diagonal direction.

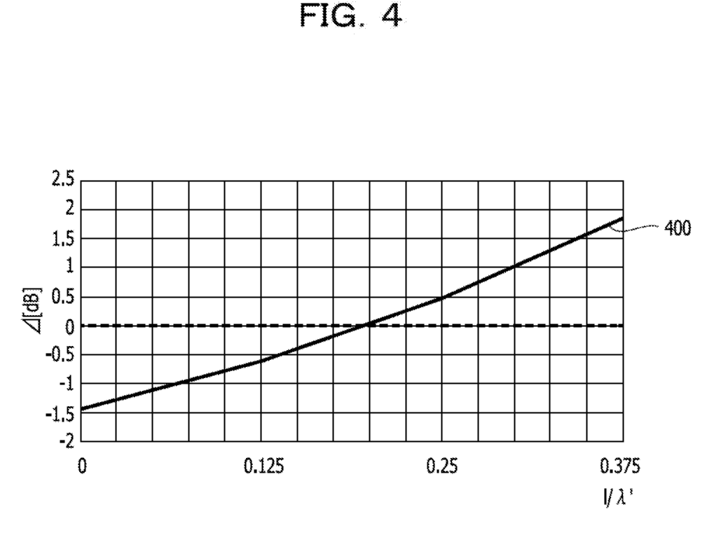

FIG. 4 is a diagram depicting results of an experiment regarding the radiation electrode 22, representing a relation between a length l of the notched portion 22a along a diagonal direction connecting the power feeding point 13 and the notched portion 22a and a difference Δ between a total gain of polarization components in the horizontal and vertical directions and a gain of polarization components in a direction at 45° with respect to the horizontal direction. Note that, as depicted in FIG. 3, the length l of the notched portion 22a is defined as a length between an end point c on the power feeding point 13 side on the diagonal line passing through the power feeding point 13 and a point of intersection d of a line extending downward from the right end of the first element 22b and a line extending rightward from the lower end of the second element 22c. In FIG. 4, the horizontal axis represents a ratio of the length l of the notched portion 22a along the diagonal direction with respect to a length λ′ (=λ/√∈) on the patch antenna 1 corresponding to the design wavelength λ, and the vertical axis represents the difference Δ [dB] between the total gain of polarization components in the horizontal and vertical directions and the gain of polarization components in the direction at 45° with respect to the horizontal direction. A graph 400 represents a relation between the ratio (l/λ′) and the gain difference Δ.

Note that by assuming that the patch antenna 1 is used in a 2 GHz band for use in the Long Term Evolution (LTE) standard, the length U in the horizontal direction and the length W′ in the vertical direction of the radiation electrode 22 were set at 36 mm. Also, the width of the first element 22b in the vertical direction and the width of the second element 22c in the horizontal direction were set at 11 mm. Furthermore, a distance between an upper end of the first element 22b and an upper end of the second element 22c and a distance between a left end of the first element 22b and a left end of the second element 22c were set at 3.5 mm. Still further, the length of the stub 22d in the vertical direction and the length of the stub 22e in the horizontal direction were set at 12 mm. Still further, a distance from the point c to a left end of the stub 22d (that is, a left end of a step above the stub 22d) and a distance from the point c to an upper end of the stub 22e (that is, an upper end of a step on the left of the stub 22e) were set at 10 mm. Still further, a difference between the width of the step above the stub 22d in the horizontal direction and the width of a step below the stub 22d in the horizontal direction was set at 5.5 mm. Similarly, a difference between the width of the step on the left of the stub 22e in the vertical direction and the width of a step on the right of the stub 22e in the vertical direction was set at 5.5 mm. Also, the lengths of the ground electrode 11 in the horizontal direction and the vertical direction were set at 70 mm. Furthermore, the thickness of the substrate 10 was set at 7.2 mm. Also, the dielectric used as the substrate 10 had a relative permittivity of 4.5 and a dielectric loss tangent of 0.014. Still further, a copper foil (a conductivity of 59×10⁶ s/m) was used for each of the radiation electrode 22 and the ground electrode 11, and the copper foil had a thickness of 35 μm.

As depicted in FIG. 4, the gain difference Δ is 0 when the ratio (l/λ′) is substantially 0.2, and is increased as the ratio (l/λ′) is further increased. Therefore, the length l of the notched portion 22a along the diagonal direction connecting the power feeding point 13 and the notched portion 22a is preferably equal to or larger than λ′/5. On the other hand, if the length l of the notched portion 22a is too long, the width of the common portion of each element is too narrow and, as a result, current becomes less prone to flowing through the radiation electrode 22. This is not preferable. The length l of the notched portion 22a is preferably set so that, for example, a length from the power feeding point 13 to an upper left end of the notched portion 22a along the diagonal direction is equal to or longer than a length from an upper left end of the radiation electrode 22 to the power feeding point 13.

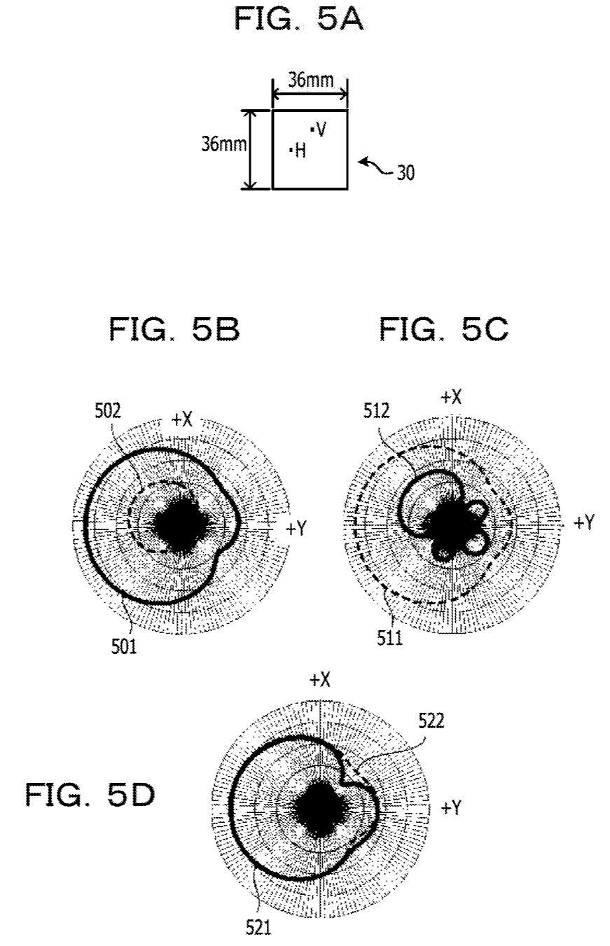

FIG. 5A is a schematic plan view of a radiation electrode of a comparative patch antenna to be used for comparison with the radiation characteristics of the patch antenna 1 according to the present embodiment. As depicted in FIG. 5A, the comparative patch antenna is assumed to use a square-shaped radiation electrode 30.

FIG. 5B and FIG. 5C are diagrams depicting results of an experiment of radiation characteristics of the comparative patch antenna. FIG. 5D is a diagram depicting results of an experiment of radiation characteristics of the patch antenna 1 using the radiation electrode 22 depicted in FIG. 3. In FIG. 5B to FIG. 5D, the X axis represents a direction parallel with the front surface of the substrate 10, and the Y axis represents the direction of the normal of the substrate 10 (a positive direction is on a ground electrode 11 side and a negative direction is on a radiation electrode 22 side). Note that, in this experiment, the dimensions and physical characteristics of each part of the patch antenna 1 were set to be equal to the dimensions and physical characteristics of each part of the patch antenna 1 in the experiment described above. Also, the dimensions and physical characteristics of each part of the comparative patch antenna were set to be equal to the dimensions and physical characteristics of each part of the patch antenna 1 in the experiment described above.

FIG. 5B represents radiation characteristics of the comparative patch antenna when power is fed to the radiation electrode 30 at a point V on the radiation electrode 30, that is, a position at W′/4 from the upper end and at the center in the horizontal direction, that is, when the patch antenna is used for vertically polarized waves. A radiation characteristic 501 is a radiation characteristic of the comparative patch antenna for vertically polarized waves when power is fed at the point V, and a radiation characteristic 502 is a radiation characteristic of the comparative patch antenna for horizontally polarized waves when power is fed at the point V.

FIG. 5C represents radiation characteristics of the comparative patch antenna when power is fed to the radiation electrode 30 at a point H on the radiation electrode 30, that is, a position at L′/4 from the left end and at the center in the vertical direction, that is, when the patch antenna is used for horizontally polarized waves. A radiation characteristic 511 is a radiation characteristic of the comparative patch antenna for horizontally polarized waves when power is fed at the point H, and a radiation characteristic 512 is a radiation characteristic of the comparative patch antenna for vertically polarized waves when power is fed at the point H.

In FIG. 5D, a radiation characteristic 521 represents a radiation characteristic of the patch antenna 1 for a vertically polarized wave, and a radiation characteristic 522 represents a radiation characteristic of the patch antenna 1 for a horizontally polarized wave. The radiation characteristic 501 depicted in FIG. 5B and the radiation characteristic 511 depicted in FIG. 5C, and the radiation characteristics 521 and 522 have almost no difference, and the radiation characteristics obtained in the patch antenna 1 are equivalent to those when power is fed to the comparative patch antenna at two positions.

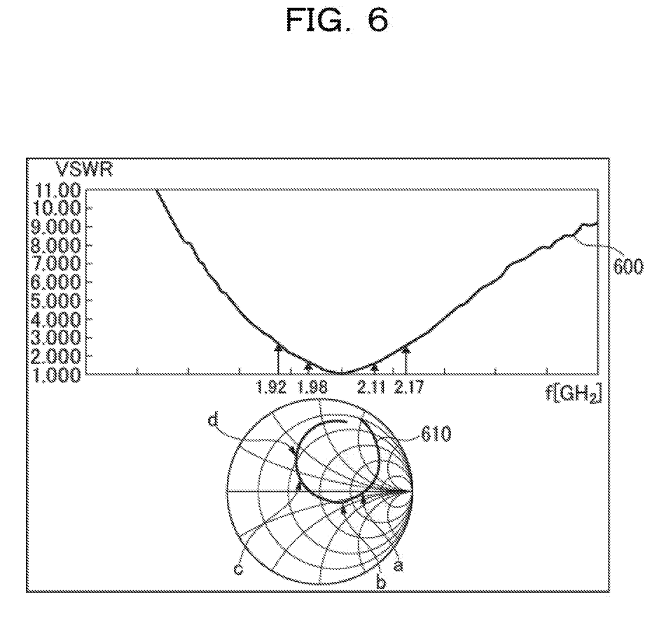

FIG. 6 is a diagram depicting results of an experiment regarding the patch antenna 1 using the radiation electrode 22 depicted in FIG. 3, representing a relation between frequency, and voltage standing wave ratio and impedance. Note that, also in this experiment, the dimensions and physical characteristics of each part of the patch antenna 1 were set to be equal to the dimensions and physical characteristics of each part of the patch antenna 1 in the experiment described above. In an upper graph in FIG. 6, the horizontal axis represents frequency, and vertical axis represents voltage standing wave ratio (VSWR). A graph 600 represents a relation between frequency and VSWR for horizontally polarized waves and vertically polarized waves in the patch antenna 1. As depicted in the graph 600, in a frequency band from 1.92 GHz to 1.98 GHz for use in an uplink of LTE and a frequency band from 2.11 GHz to 2.17 GHz for use in a downlink of LTE, VSWR is smaller than 3, which is a limit in practical use.

A graph 610 in a Smith chart centering at 50Ω depicted on a lower side of FIG. 6 represents a relation between frequency and impedance for horizontally polarized waves and vertically polarized waves in the patch antenna 1. Points a, b, c, and d represent 1.92 GHz, 1.98 GHz, 2.11 GHz, and 2.17 GHz, respectively. As depicted in the graph 610, in the frequency band from 1.92 GHz to 1.98 GHz and the frequency band from 2.11 GHz to 2.17 GHz, impedance matching is relatively favorably established in the patch antenna 1.

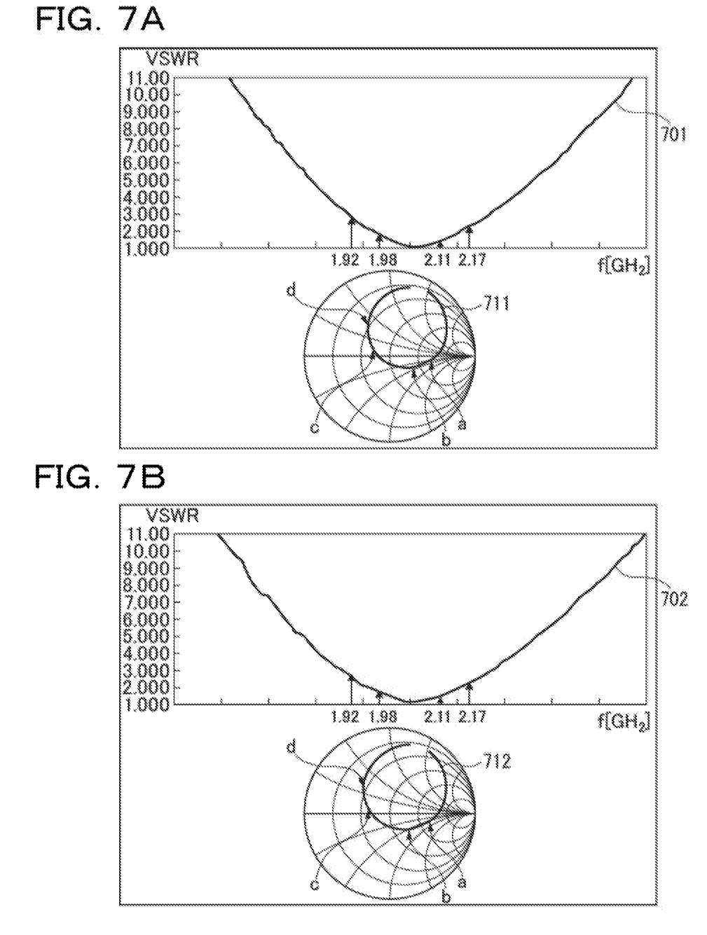

FIG. 7A depicts results of an experiment regarding the comparative patch antenna depicted in FIG. 5A, representing a relation between frequency, and VSWR and impedance when power is fed to the radiation electrode at the power feeding point V, that is, when the comparative patch antenna is used for vertically polarized waves. FIG. 7B depicts results of an experiment regarding the comparative patch antenna depicted in FIG. 5A, representing a relation between frequency, and VSWR and impedance when power is fed to the radiation electrode at the power feeding point H, that is, when the comparative patch antenna is used for horizontally polarized waves. In FIG. 7A and FIG. 7B, in an upper graph, the horizontal axis represents frequency, and the vertical axis represents VSWR. A graph 701 represents a relation between frequency and VSWR for vertically polarized waves in the comparative patch antenna. A graph 702 represents a relation between frequency and VSWR for horizontally polarized waves in the comparative patch antenna. In comparison between the graphs 701 and 702 and the graph 600, in the frequency band from 1.92 GHz to 1.98 GHz and the frequency band from 2.11 GHz to 2.17 GHz, the frequency characteristics for VSWR are substantially identical between the patch antenna 1 and the comparative patch antenna.

Also, in FIG. 7A and FIG. 7B, Smith charts on a lower side are those centering at 50Ω. A graph 711 represents a relation between frequency and impedance for vertically polarized waves in the comparative patch antenna. Similarly, a graph 712 represents a relation between frequency and impedance for horizontally polarized waves in the comparative patch antenna. Points a, b, c, and d represent 1.92 GHz, 1.98 GHz, 2.11 GHz, and 2.17 GHz, respectively. In comparison between the graphs 711 and 712 and the graph 610, in the frequency band from 1.92 GHz to 1.98 GHz and the frequency band from 2.11 GHz to 2.17 GHz, the frequency characteristics for impedance are substantially identical between the patch antenna 1 and the comparative patch antenna.

As has been described above, with power being fed from one power feeding point where impedance matching is established in the radiation electrode for both of horizontally polarized waves and vertically polarized waves, the patch antenna of the embodiment may be used for both of horizontally polarized waves and vertically polarized waves. Thus, the patch antenna of the embodiment may simplify the circuit structure for power feeding. Also, with a notched portion provided to the radiation electrode on a diagonal side with respect to the power feeding point, the patch antenna of the embodiment may improve radiation efficiency for horizontally polarized waves and vertically polarized waves.

Note that the present disclosure is not restricted to the above-described embodiment. For example, instead of being provided on the upper left end of the radiation electrode, the power feeding point may be provided on an upper right end, lower left end, or lower right end of the radiation electrode. In any case, with reference to one end of the radiation electrode near the power feeding point, the power feeding point may be provided at a position where the condition represented by the expression (2) is satisfied.

Also, the radiation electrode may have a shape different from that of the embodiment or modification example described above, as long as the power feeding point is provided at a position where impedance matching is established in the radiation electrode for both of horizontally polarized waves and vertically polarized waves and a notched portion is formed on a diagonal side with respect to the power feeding point.

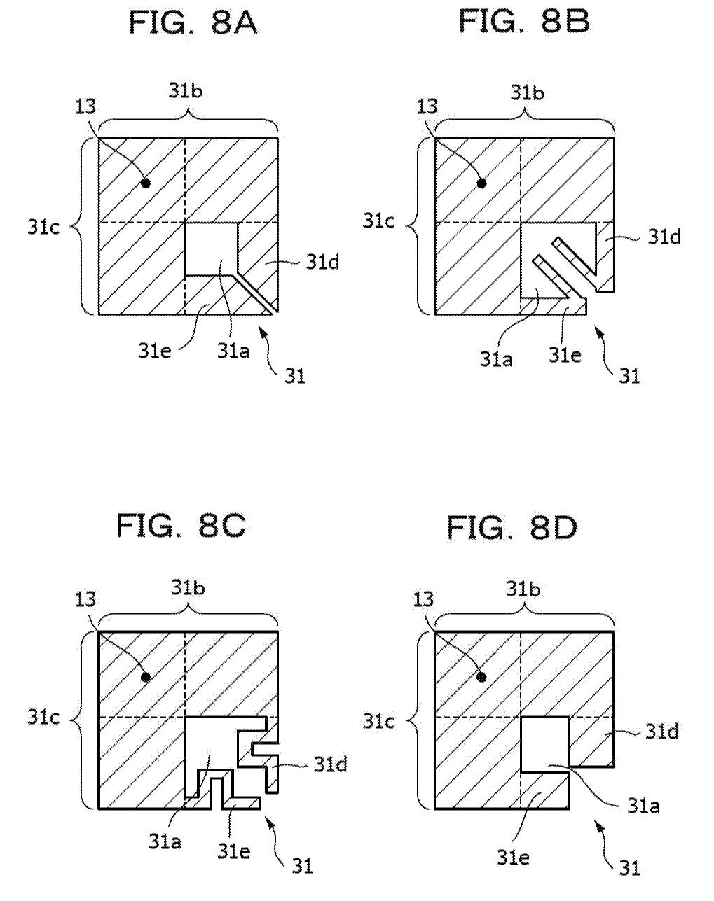

FIG. 8A to FIG. 8D are schematic plan views of radiation electrodes according to modification examples. Radiation electrodes 31 depicted in FIG. 8A to FIG. 8D are each provided with the power feeding point 13 commonly used for horizontally polarized waves and vertically polarized waves at a position where the expression (2) is satisfied. In any of the radiation electrodes 31, a recessed-shaped notched portion 31a is provided on a diagonal side with respect to the power feeding point 13 in order to improve current density with respect to horizontally polarized waves and vertically polarized waves. Furthermore, in any of the radiation electrodes 31, stubs 31d and 31e are formed of a first element 31b for horizontally polarized waves and a second element 31c for vertically polarized waves, respectively, so as to be opposed to each other. For example, in FIG. 8A, the stubs 31d and 31e are each formed in a trapezoidal shape. Also in FIG. 8B, the stub 31d is formed in a shape obtained by coupling a linear portion along a right end of the radiation electrode 31 and a linear portion along a diagonal line passing through the power feeding point 13, and the stub 31e is formed in a shape obtained by coupling a linear portion along a lower end of the radiation electrode 31 and a linear portion along the diagonal line passing through the power feeding point 13. Furthermore, in FIG. 8C, the stubs 31d and 31e are each formed in a meandering shape. In FIG. 8D, the stubs 31d and 31e are each formed in a rectangular shape. Thus, also when the radiation electrode 31 is used, effects similar to those when the radiation electrode 22 depicted in FIG. 3 is used may be obtained.

Also for each of the radiation electrodes 31 depicted in FIG. 8A to FIG. 8D, the radiation electrode 31 is symmetrically formed with respect to the diagonal direction passing through the power feeding point 13 so that a difference between the radiation characteristics for horizontally polarized waves and the radiation characteristics for vertically polarized waves is decreased. However, if the difference between the radiation characteristics for horizontally polarized waves and the radiation characteristics for vertically polarized waves is allowable to some extent, the radiation electrode 31 may not be formed symmetrically with respect to the diagonal direction passing through the power feeding point 13. For example, the first element and its first stub may each have a shape depicted in FIG. 8A and, on the other hand, the second element and its second stub may each have a shape depicted in FIG. 3 or any of FIG. 8B to FIG. 8D. Furthermore, a stub as depicted in FIG. 3 or any of FIG. 8A to FIG. 8D may be formed on only either one of the first element and the second element.

Also, the patch antenna according to the present embodiment or any of the modification examples may be suitably used for, by way of example, a base station in mobile communication, such as a base station which provides a cell in a relatively small range, for example, microcell, nanocell, or femtocell. Alternatively, the patch antenna according to the present embodiment or any of the modification examples may be used for a mobile station. Still alternatively, the patch antenna according to the present embodiment or any of the modification examples may be used for another purpose in wireless communication. Still alternatively, the patch antenna according to the present embodiment or any of the modification examples may be used as one of antenna elements forming an array antenna.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A patch antenna comprising:
a substrate formed of a dielectric;
a conductive ground electrode disposed on one surface of the substrate; and
a conductive radiation electrode disposed on another surface of the substrate, wherein
the conductive radiation electrode includes
a first element configured to radiate or receive a first linearly polarized wave with a predetermined design wavelength having a plane of polarization along a first direction,
a second element configured to radiate or receive a second linearly polarized wave with the predetermined design wavelength having a plane of polarization along a second direction orthogonal to the first direction and have a portion common to the first element,
a power feeding point provided at a position where impedance matching is established in the conductive radiation electrode for the first linearly polarized wave and the second linearly polarized wave in the portion common to the first element and the second element, and
a notched portion formed between the first element and the second element along a diagonal direction passing through the power feeding point, the notched portion configured to equally divide a corner between the first direction and the second direction into two.

2. The patch antenna according to claim 1, wherein
the conductive radiation electrode further includes
a first stub formed from an end of the first element away from the power feeding point toward the second element, and
a second stub formed from an end of the second element away from the power feeding point toward the first element and disposed so as not to electrically make contact with the first stub, and
the first element has a length along the first direction, the length having a value obtained by dividing the predetermined design wavelength by a value obtained by doubling a square root of a relative permittivity of the substrate, and the second element has a length along the second direction, the length having a value obtained by dividing the predetermined design wavelength by the value obtained by doubling the square root of the relative permittivity of the substrate.

3. The patch antenna according to claim 1, wherein
the notched portion has a length along the diagonal direction, the length set at a value so that a total gain for the first linearly polarized wave and the second linearly polarized wave regarding the patch antenna is larger than a gain of a linearly polarized wave in a direction at 45° with respect to the first direction and the second direction.

4. The patch antenna according to claim 3, wherein
the notched portion has a length along the diagonal direction, the length set at a value equal to or larger than ⅕ of a value obtained by dividing the predetermined design wavelength by a square root of a relative permittivity of the substrate.

5. The patch antenna according to claim 1, wherein
the conductive radiation electrode is symmetrically formed with respect to the diagonal direction.
